(19) United States
(12) Patent Application Publication
(10) Pub. No.: US 2026/0349984 A1
(43) Pub. Date: Nov. 5, 2026

(54) METHOD AND SYSTEM FOR GENERATING A MONTE CARLO TREE SEARCH ALGORITHM THAT DETECTS DATA PATTERNS

(71) Applicant: JPMorgan Chase Bank, N.A., New York, NY (US)

(72) Inventors: Pietro TOTIS, Martignacco (IT); Alberto POZANCO, Madrid (ES); Daniel BORRAJO, Pozuelo de Alarcon (ES)

(73) Assignee: JPMorgan Chase Bank, N.A., New York, NY (US)

(21) Appl. No.: 19/198,746

(22) Filed: May 5, 2025

(51) Int. Cl. G06F 16/22; G06F 16/2455; G06F 18/26

(52) U.S. Cl. CPC G06F 16/2246; G06F 16/2455; G06F 18/26

(57) ABSTRACT

A method and system for generating a Monte Carlo tree search (MCTS) algorithm that detects data patterns. The method includes performing a data transformation of a digital data set comprising a creation of at least one subset of the digital data set and a derivation of data features from the digital data set, and constructing a virtual decision tree. The method also includes generating a MCTS algorithm, and traversing a first branch of the virtual decision tree during an exploitation phase of the MCTS algorithm that recursively searches each node of the first branch to detect a predetermined data pattern. The method also includes performing an action during an exploration phase of the MCTS algorithm, simulating an outcome based on the performed action, and updating the MCTS algorithm by backpropagating a path score associated with the first branch based on the simulated outcome.

### FIELD OF THE DISCLOSURE

This technology generally relates to methods and systems for generating a Monte Carlo tree search algorithm that detects data patterns.

### BACKGROUND INFORMATION

In the era of big data, the ability to extract meaningful insights from vast amounts of information is crucial for decision-making across various domains. Automatic insights extraction and data exploration using Artificial Intelligence (AI) have emerged as necessary tools to close the gap between the amount of data generated and the ability to process and understand it. These technologies enable organizations to uncover hidden patterns, trends, and relationships within their data, facilitating informed decisions and strategic planning.

The relevance of automatic insights lies in their potential to enhance productivity, drive innovation, and provide a competitive edge by enabling data-driven decision-making processes. As data continues to grow in volume and complexity, the demand for efficient and effective data exploration techniques becomes increasingly important. AI-driven solutions offer the promise of automating the labor-intensive process of data analysis, allowing businesses and researchers to focus on interpreting results and making informed decisions.

Accordingly, there is a need for techniques for detection of data patterns by an AI algorithm.

### SUMMARY

The present disclosure, through one or more of its various aspects, embodiments, and/or specific features or sub-components, provides, inter alia, various systems, servers, devices, methods, media, programs, and platforms for generating a Monte Carlo tree search algorithm that detects data patterns.

According to an aspect of the present disclosure, a method of generating a Monte Carlo tree search algorithm that detects data patterns time may be provided. The method may be implemented by at least one processor. The method may include performing a data transformation of a digital data set comprising a creation of at least one subset of the digital data set and a derivation of data features from the digital data set. The method may also include constructing a virtual search tree with each node of the virtual search tree corresponding to the at least one subset of the digital data set with the derived data features. The method may also include generating a Monte Carlo tree search (MCTS) algorithm, and traversing a first branch of the virtual search tree by the MCTS algorithm during an exploitation phase of the MCTS algorithm that recursively searches each node of the first branch to detect a predetermined data pattern. The method may also include performing an action during an exploration phase of the MCTS algorithm upon the detection of the predetermined data pattern, simulating an outcome based on the performed action, and updating the MCTS algorithm by backpropagating a path score associated with the first branch based on the simulated outcome.

The predetermined data pattern may include a predetermined interestingness metric. The predetermined interestingness metric comprises a relevance dimension, a surprise dimension, a novelty dimension, and a peculiarity dimension. The action may include a data action and a pattern action.

The performing the data transformation may further include combining primitive data types obtained from the digital data set, and constructing tabular data from a raw data obtained from the digital data set.

The method may further include, upon not reaching a predetermined number of iterations of the MCTS algorithm, traversing a second branch of the virtual search tree by the MCTS algorithm during the exploitation phase of the MCTS algorithm that recursively searches each node of the second branch to detect the predetermined data pattern.

The method may further include performing an expansion by choosing the action that constructs additional nodes in the virtual search tree.

The generating the MCTS algorithm may include a computation of an upper confidence bound associated with the virtual search tree that comprises an average reward metric at the node, a number of visits at a parent node, a number of visits at the node, and a hyperparameter associated with the MCTS algorithm.

The traversing of the first branch by the MCTS algorithm may begin at a parent node and continues to a leaf node in the virtual search tree.

According to another embodiment, a computing apparatus for generating a Monte Carlo tree search algorithm that detects data patterns may be provided. The computing apparatus may include: a processor; a memory; a display; and a communication interface coupled to each of the processor, the memory, and the display.

The processor may be configured to perform a data transformation of a digital data set comprising a creation of at least one subset of the digital data set and a derivation of data features from the digital data set. The processor may be also configured to construct a virtual search tree with each node of the virtual search tree corresponding to the at least one subset of the digital data set with the derived data features, and generate a Monte Carlo tree search (MCTS) algorithm. The processor may be also configured to traverse a first branch of the virtual search tree by the MCTS algorithm during an exploitation phase of the MCTS algorithm that recursively searches each node of the first branch to detect a predetermined data pattern. The processor may be also configured to perform an action during an exploration phase of the MCTS algorithm upon the detection of the predetermined data pattern, simulate an outcome based on the performed action, and update the MCTS algorithm by backpropagating a path score associated with the first branch based on the simulated outcome.

The predetermined data pattern may include a predetermined interestingness metric. The predetermined interestingness metric may include relevance dimension, a surprise dimension, a novelty dimension, and a peculiarity dimension. The action may include a data action and a pattern action.

The processor may be further configured to perform the data transformation by combining primitive data types obtained from the digital data set, and constructing tabular data from a raw data obtained from the digital data set.

The processor may be further configured to, upon not reaching a predetermined number of iterations of the MCTS algorithm, traverse a second branch of the virtual search tree by the MCTS algorithm during the exploitation phase of the MCTS algorithm that recursively searches each node of the second branch to detect the predetermined data pattern.

The processor may be further configured to perform an expansion by choosing the action that constructs additional nodes in the virtual search tree.

The processor may be further configured to generate the MCTS algorithm by computing an upper confidence bound associated with the virtual search tree that comprises an average reward metric at the node, a number of visits at a parent node, a number of visits at the node, and a hyperparameter associated with the MCTS algorithm.

The processor may be further configured to traverse the first branch by the MCTS algorithm by beginning at a parent node and continuing to a leaf node in the virtual search tree.

According to yet another embodiment, non-transitory computer readable storage medium storing instructions for generating a Monte Carlo tree search algorithm that detects data patterns may be provided. The non-transitory computer readable storage medium may include executable code which, when executed by a processor, may cause the processor to perform a data transformation of a digital data set comprising a creation of at least one subset of the digital data set and a derivation of data features from the digital data set. The non-transitory computer readable storage medium may also cause the processor to construct a virtual search tree with each node of the virtual search tree corresponding to the at least one subset of the digital data set with the derived data features, and generate a Monte Carlo tree search (MCTS) algorithm. The non-transitory computer readable storage medium may also cause the processor to traverse a first branch of the virtual search tree by the MCTS algorithm during an exploitation phase of the MCTS algorithm that recursively searches each node of the first branch to detect a predetermined data pattern. The non-transitory computer readable storage medium may also cause the processor to perform an action during an exploration phase of the MCTS algorithm upon the detection of the predetermined data pattern, simulate an outcome based on the performed action, and update the MCTS algorithm by backpropagating a path score associated with the first branch based on the simulated outcome.

The predetermined data pattern may include a predetermined interestingness metric. The predetermined interestingness metric may include a relevance dimension, a surprise dimension, a novelty dimension, and a peculiarity dimension. The action may include a data action and a pattern action.

The non-transitory computer readable storage medium may also cause the processor to perform the data transformation by combining primitive data types obtained from the digital data set, and constructing tabular data from a raw data obtained from the digital data set.

The non-transitory computer readable storage medium may also cause the processor to, upon not reaching a predetermined number of iterations of the MCTS algorithm, traverse a second branch of the virtual search tree by the MCTS algorithm during the exploitation phase of the MCTS algorithm that recursively searches each node of the second branch to detect the predetermined data pattern.

The non-transitory computer readable storage medium may also cause the processor to perform an expansion by choosing the action that constructs additional nodes in the virtual search tree.

The non-transitory computer readable storage medium may also cause the processor to generate the MCTS algorithm by computing an upper confidence bound associated with the virtual search tree that comprises an average reward metric at the node, a number of visits at a parent node, a number of visits at the node, and a hyperparameter associated with the MCTS algorithm, and traverse the first branch by the MCTS algorithm by beginning at the parent node and continuing to a terminal leaf node in the virtual search tree.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for generating a generating a Monte Carlo tree search algorithm that detects data patterns.

FIG. 4 illustrates a flowchart of a process diagram for generating a Monte Carlo tree search algorithm that detects data patterns according to an embodiment.

FIG. 5 illustrates an example overview framework process of the generating a Monte Carlo tree search algorithm that detects data patterns according to an embodiment.

FIG. 6 illustrates an example of the Monte Carlo tree search algorithm process as it traverses through a virtual search tree based on the generating a Monte Carlo tree search algorithm that detects data patterns according to an embodiment.

FIG. 7 illustrates an example pseudocode based on the generating a Monte Carlo tree search algorithm that detects data patterns according to an embodiment.

FIG. 8 illustrates an example of various nodes of a virtual search tree and traversing through the various nodes based on the generating a Monte Carlo tree search algorithm that detects data patterns according to an embodiment.

### DETAILED DESCRIPTION

In the era of big data, the ability to extract meaningful insights from vast amounts of information is crucial for decision-making across various domains. Automatic insights extraction and data exploration using Artificial Intelligence (AI) have emerged as necessary tools to close the gap between the amount of data generated and the ability to process and understand it. These technologies enable organizations to uncover hidden patterns, trends, and relationships within their data, facilitating informed decisions and strategic planning.

The relevance of automatic insights lies in their potential to enhance productivity, drive innovation, and provide a competitive edge by enabling data-driven decision-making processes. As data continues to grow in volume and complexity, the demand for efficient and effective data exploration techniques becomes increasingly important. Indeed, various fundamental challenges in the status quo are discussed below.

One example of a fundamental challenge in the status quo relates to feature generation associated with large datasets, which can be a cumbersome and tedious process. Feature generation is a critical process to detect meaningful patterns because it enables the identification and creation of relevant features from raw data, which is critical for effective data exploration. However, within the status quo, the current techniques for feature generation can be complex and time-consuming, requiring domain expertise and a deep understanding of the data, which might not be readily available and is difficult to achieve when large datasets are involved.

Another example of fundamental challenge in the status quo is regarding pattern detection. This is another critical aspect because it is critical to detect meaningful patterns within large datasets to have insight on the large datasets. The present algorithms in the status quo would need to be capable of identifying significant trends and correlations while distinguishing these significant trends and correlations from noise with the large datasets. In order to do so would require sophisticated techniques that can handle diverse data types and structures, as well as the ability to scale with increasing data volumes. Such sophisticated techniques might not be readily available within the status quo.

Another example of fundamental challenge in the status quo is regarding pattern evaluation. Once patterns are detected, evaluating their significance and relevance is crucial. This involves assessing the validity and reliability of the insights generated, as well as their potential impact on decision-making. Pattern evaluation requires robust statistical methods and validation techniques to ensure that the insights are both accurate and actionable, which can be a cumbersome and tedious process.

Another example of fundamental challenge in the status quo is regarding feedback, e.g., learning from user feedback. Incorporating user feedback and knowledge into the algorithmic data exploration process may be essential for refining and improving the quality of insights. User expertise may provide valuable context and interpretation, guiding the algorithm to focus on relevant patterns and discard irrelevant ones. However, integrating user feedback into algorithms and automated system process may pose challenges in terms of designing intuitive interfaces and ensuring seamless collaboration between the user and the systems operating such as algorithms and automated processes.

As such, the present application discloses an AI-driven solution via an AI algorithm that provides meaningful insights derived from analyzing large datasets and providing the meaningful insights to the user (e.g., a person, a business organization, a researcher/programmer, etc.) in a manner that allows the user to focus on interpreting results and making informed decisions.

Notably, the present application improves on the status quo and provides a technological improvement by disclosing techniques and processes related to a Monte Carlo tree search (MCTS) algorithm and its generation that provides an improved process for detecting data patterns and improving system resource usage. This may be achieved by providing an efficient technique involving virtual search trees and the MCTS algorithm for efficiently searching through and analyzing a large dataset space. This MCTS algorithm provides an improvement on computing system resource usages because the MCTS algorithm can succinctly search through and analyze the large dataset space in an efficient and timely manner through the exploration phase and exploitation phase of the MCTS algorithm as it traverses the virtual search tree associated with the large datasets.

The present application provides techniques for detecting patterns in data (e.g., large digital datasets) that are given in tabular form to automatically detect interesting patterns in the data. Indeed, the challenge of navigating a vast and potentially infinite space of data transformations and pattern generation techniques represents a significant hurdle in the field of automated insights extraction and data analysis. This challenge is rooted in the need to effectively balance two critical phases of knowledge discovery: exploration and exploitation. The exploration phase involves the selection or derivation of potentially useful features from raw data. This phase can be crucial for identifying the variables that may capture underlying patterns and relationships within the data. However, exploration alone is not sufficient. It needs to also be complemented by the exploitation phase, where the focus shifts to searching for patterns and correlations between the selected features. The goal is to maximize a predetermined metric of interest (i.e., predetermined interestingness metric), which requires a strategic balance between exploring new possibilities and exploiting known patterns.

The MCTS algorithm addresses this complex problem because it is a strategic algorithm with an exploration phase and exploitation phase that can navigate a large and complex associated with large datasets. The strength of MCTS algorithm lies in its ability to simulate various paths within the decision space and evaluate their potential outcomes. By doing so, the MCTS algorithm can effectively balance exploration and exploitation, ensuring that the search for optimal solutions is both thorough and efficient.

Indeed, within the context of data transformation and pattern generation, the MCTS can be utilized to navigate the expansive space of possible data transformations and feature combinations. During the exploration phase, the MCTS algorithm can systematically explore different data transformations and feature derivations to identify those that hold potential for uncovering meaningful insights. Once promising features are identified, the MCTS algorithm transitions to the exploitation phase, where it intensively searches for patterns and relationships among these features. This dual-phase approach enables the MCTS algorithm to maximize the interestingness of the insights generated, ensuring that the most relevant and impactful patterns are discovered.

Moreover, the MCTS algorithm's iterative nature allows for continuous refinement of the intensive search process. As new data becomes available or as the understanding of the data evolves, the MCTS algorithm can learn and adapt by revisiting previous decisions and exploring alternative paths. This learning and adaptability aspects of the MCTS algorithm are particularly valuable in dynamic environments where data characteristics and business objectives changes over time.

As such, the MCTS algorithm provides a robust framework for balancing exploration and exploitation in the realm of data transformation and pattern generation. By strategically navigating the decision space, the MCTS algorithm enhances the efficiency and effectiveness of the knowledge discovery process, ultimately leading to more insightful and actionable data-driven decisions. This approach not only addresses the inherent challenges of searching vast data spaces but also paves the way for sophisticated and intelligent data exploration techniques.

The present application can leverage an unsupervised MCTS algorithm framework that operates with minimal user input. This approach has demonstrated its effectiveness in navigating the vast and complex space of data transformations, enabling the discovery of meaningful insights with a high degree of interestingness. By systematically exploring potential features and intensively searching for patterns, the MCTS algorithm operating unsupervised has proven to be a valuable tool in the automatic insights and data exploration landscape.

The MCTS algorithm can incorporate user input as part of enriching the MCTS algorithm's exploration phase. For instance, domain knowledge and expertise may be inputted into the MCTS algorithm to help guide the MCTS algorithm so that it can more effectively enable the exploration phase to be aligned with domain-specific insights and priorities of the user. This guided approach has the potential to enhance the relevance and applicability of the insights generated, making them more actionable and contextually meaningful.

In addition to incorporating domain knowledge, Large Language Models (LLMs) may also be leveraged to provide general knowledge that can further inform the MCTS algorithm's exploration phase. LLMs, with their vast understanding of language and context, can offer valuable insights and suggestions that may not be immediately apparent through traditional data analysis methods. By integrating LLMs into the MCTS algorithm framework, the MCTS algorithm's ability to identify novel patterns and relationships can be enhanced, ultimately leading to more comprehensive and insightful data exploration.

Furthermore, user feedback can also be integrated into the MCTS algorithm by enabling users to provide feedback on each insight generated by the MCTS algorithm. This feedback can help to facilitate a continuous learning loop for the MCTS algorithm, enabling it to refine its search strategies and improve over time. This feedback mechanism can help to enhance the accuracy and relevance of the insights of the MCTS algorithm, while also fostering a collaborative environment where user expertise and machine intelligence can work in tandem to achieve optimal results.

For these various reasons, the present application provides a technological improvement of the status quo. Further details of the present application are provided below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

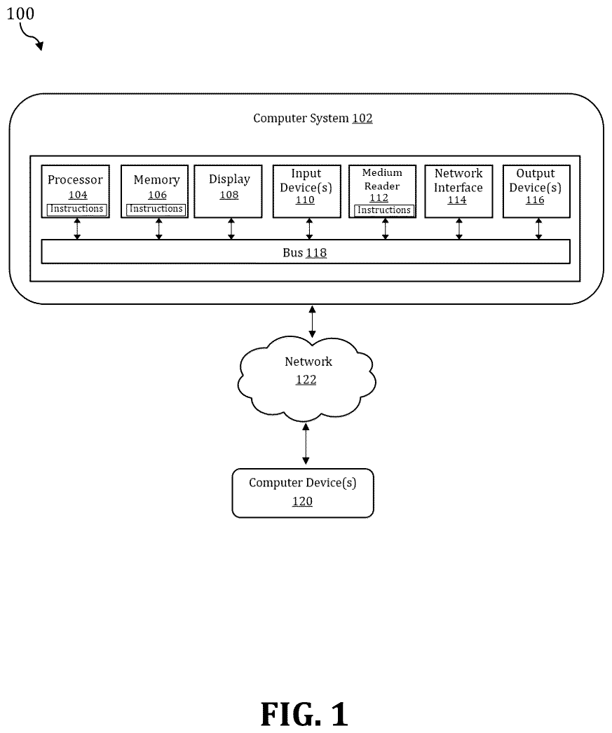

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide for generating the MCTS algorithm that detects data patterns.

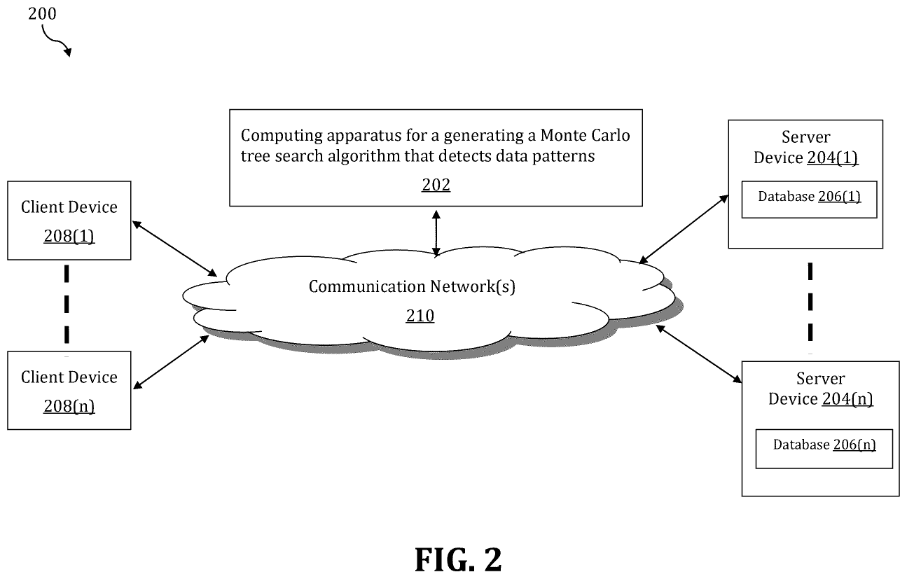

Referring to FIG. 2, a network diagram of a network environment 200 for generating the MCTS algorithm that detects data patterns may be illustrated. In an embodiment, the method may be executable on any networked computer platform, such as, for example, a personal computer (PC).

The methods for generating the MCTS algorithm that detects data patterns may be implemented by a computing apparatus 202 that implements the generating of the MCTS algorithm that detects data patterns. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for generating the MCTS algorithm that detects data patterns.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

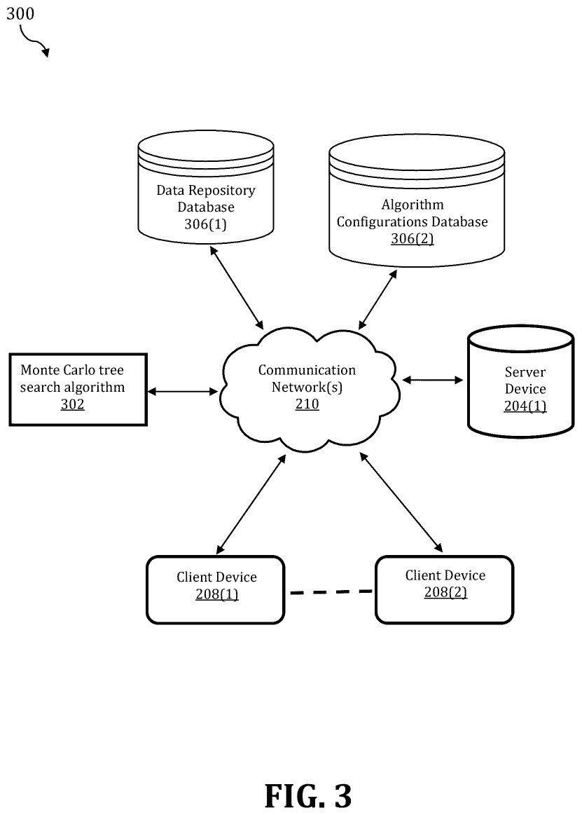

The computing apparatus 202 may be described and illustrated in FIG. 3 as may include a Monte Carlo tree search (MCTS) algorithm 302, although it may include other rules, algorithms, policies, modules, databases, or applications, for example. As will be described below, the MCTS algorithm 302 may be configured to implement method of generating the MCTS algorithm that detects data patterns.

FIG. 3 illustrates a diagram of a system environment 300 for implementing method of generating the MCTS algorithm that detects data patterns by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The MCTS algorithm 302 may be configured to access these databases for implementing the method of generating the MCTS algorithm that detects data patterns.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

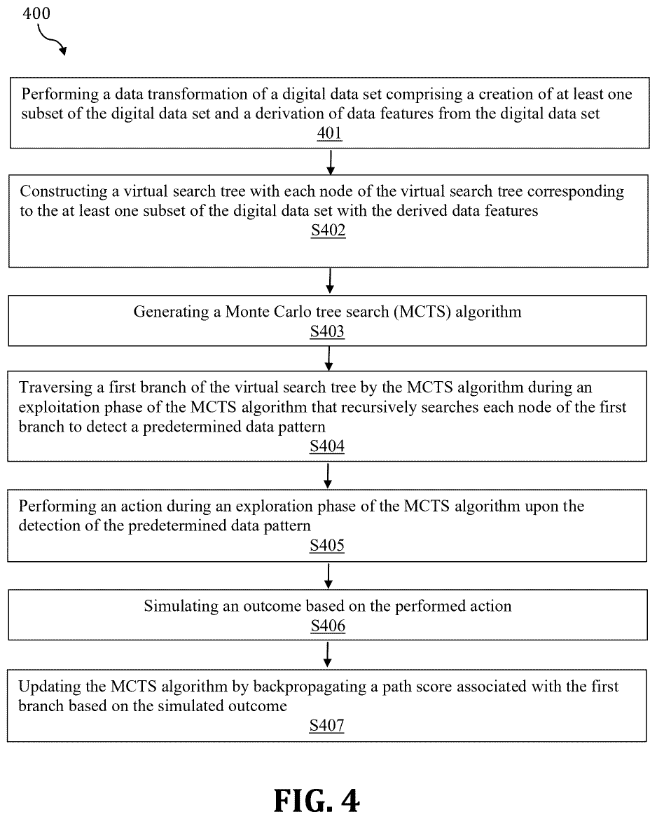

The MCTS algorithm 302 may execute a process implementing method of generating the MCTS algorithm that detects data patterns. The process for generating the MCTS algorithm that detects data patterns may be generally indicated at flowchart 400 in FIG. 4.

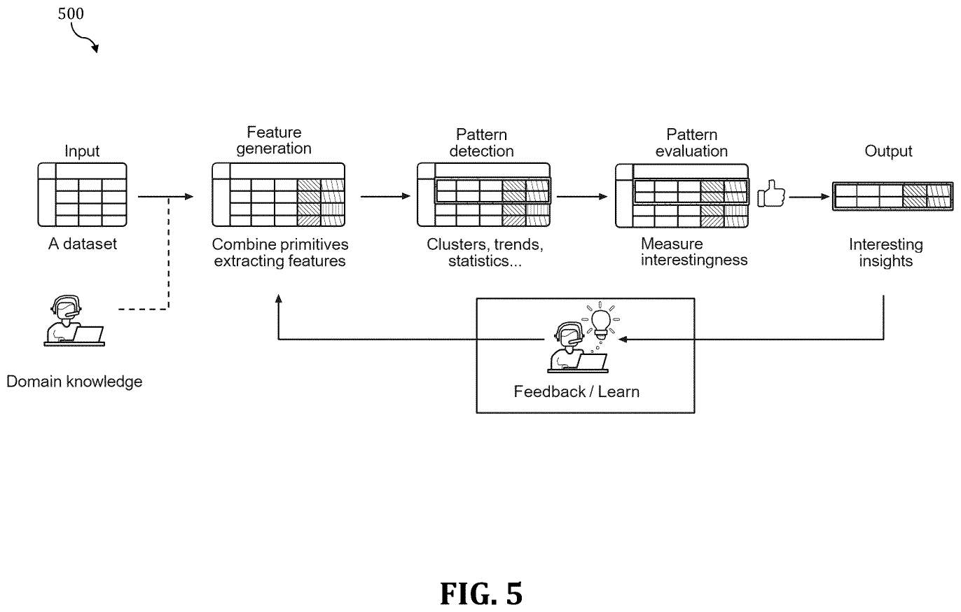

FIG. 4 illustrates a flowchart of a process diagram 400 of a process for generating the MCTS algorithm that detects data patterns according to an embodiment. The process diagram 400 may be implemented by the system environment 300 of FIG. 3, a network environment 200 of FIG. 2, and the system 100 of FIG. 1. The steps in FIG. 4 may be further described in FIGS. 5-8.

At step S401 of the flowchart process 400, the computing apparatus 202 may perform a data transformation of a digital data set comprising a creation of at least one subset of the digital data set and a derivation of data features from the digital data set. Performing the data transformation may include combining primitive data types obtained from the digital data set, and constructing tabular data from a raw data obtained from the digital data set. Examples of primitive data types may include, but are not limited to: integers, Booleans, character, byte, float, string, etc. That is, primitive data types may denote data types at their basic/fundamental format and cannot be divided into any additional type of data.

At step S402 of the flowchart process 400, the computing apparatus 202 may construct a virtual search tree with each node of the virtual search tree corresponding to the at least one subset of the digital data set with the derived data features. The computing apparatus 202 may also perform an expansion by choosing the action that constructs additional nodes in the virtual search tree.

At step S403 of the flowchart process 400, the computing apparatus 202 may generate a MCTS algorithm. Generating the MCTS algorithm may include a computation of an upper confidence bound associated with the virtual search tree that comprises an average reward metric at the node, a number of visits at a parent node, a number of visits at the node, and a hyperparameter associated with the MCTS algorithm. That is, the MCTS algorithm may be generated based on computing upper confidence bounds (UCB) applied for the virtual search trees, which may be denoted as UCBT:

$$UCBT ( {node}_{i} ) = \frac{{w}_{i}}{{n}_{i}} + c \sqrt{\frac{ln {N}_{i}}{{n}_{i}}} .$$

The term

$$\frac{{w}_{i}}{{n}_{i}}$$

may represent the average reward metric at the node. The term c may represent the hyperparameter. The term ln Nᵢ may represent the number of visits at a parent node. The term nᵢ may be represent the number of visits at the node.

At step S404 of the flowchart process 400, the computing apparatus 202 may traverse a first branch of the virtual search tree by the MCTS algorithm during an exploitation phase of the MCTS algorithm that recursively searches each node of the first branch to detect a predetermined data pattern. The exploitation phase may include a recursive search, i.e., a recursive selection phase, to exploit actions that have been tested in a previous iteration of the MCTS algorithm and for which there is a score estimate associated with a real ground-truth outcome. The predetermined data pattern may denote at least one subset of the digital data set with a promising data pattern. The predetermined data pattern may include a predetermined interestingness metric. The predetermined interestingness metric may include a combination of a relevance dimension, a surprise dimension, a novelty dimension, and a peculiarity dimension.

A relevance dimension may denote an element that is closest to an information goal. A surprise dimension may denote an element that is far from or outside of the beliefs and expectations of the user. A novelty dimension may denote an element that is unknown to the user. A peculiarity dimension may denote an element that is different from other information (e.g., statistical outliers, significance, coverage, coherence, etc.). Examples of statistical outliers may include z-scores, correlations, etc. Examples of the peculiarity dimension may also include association rules with high confidence and support, and high accuracy and coverage associated with a virtual decision tree.

Continuing with step S404, computations of the predetermined interestingness metric may include computations of univariate statistics, bivariate statistics (e.g., correlations), association rules, virtual decision trees, time series, group outliers, and aggregation. The univariate statistics may be computed by taking an average of values (e.g., entropy, skewness, kurtosis, inter-quantile range, etc.). These values, except for entropy, may be capped to a threshold as determined by the user (i.e., an arbitrary threshold as determined by the user). The inter-quantile range may depend on a unit of measure associated with data and can denote e.g., a first to a third inter-quantile range, although any other inter-quantile range as desired may be utilized.

The bivariate statistics (e.g., correlations) may be computed as:

$$2 * ( \frac{\# of high correlation pairs}{{( \# of features )}^{2}} ) .$$

The association rules may be computed as: (|0.5−kulczynski|*imbalance_ratio). The Kulczynski measure may denote a measure of probability that a rule may hold with regards to the data. That is, it may be a measure of how unlikely a rule is to hold with regards to an aspect/consequence of the data. The imbalance_ratio may be a value between zero and one and may measure a percentage of occurrence an aspect/consequence of the data occurs.

The high accuracy and coverage associated with the virtual decision trees may be computed as: (accuracy*coverage*target entropy). The time series may be computed as:

$$( \frac{has period + has trend + has outliers}{3} ) .$$

The group outliers may be computed as:

$$max groups * ( \frac{zscore * ln ( group size )}{max group score} ) .$$

The aggregation may be computed using a root mean square, which can provide a bit more weight to large values.

Continuing with step S404, the traversing of the first branch by the MCTS algorithm begins at a parent node and continues to a leaf node in the virtual search tree.

Continuing with step S404, upon not reaching a predetermined number of iterations of the MCTS algorithm, then traversing a second branch of the virtual search tree by the MCTS algorithm during the exploitation phase of the MCTS algorithm that recursively searches each node of the second branch to detect the predetermined data pattern.

The exploration phase of the MCTS algorithm may select or derive useful features and test different techniques to select or derive these useful features. The exploitation phase of the MCTS algorithm may focus on a specific subset of the digital data refining the patterns. The MCTS algorithm strategically explores decision spaces to identify optimal solutions by balancing the exploration phase and the exploitation phase, which enables the predetermined interestingness metric to be maximized.

At step S405 of the flowchart process 400, the computing apparatus 202 may perform an action during an exploration phase of the MCTS algorithm upon the detection of the predetermined data pattern. The action may include a data action and a pattern action. That is, actions may have pre-conditions and constraints that change dynamically with a subset of data, whereby this dynamic change is desirable since it helps to prevent repetitions of actions. The exploration phase may include exploring actions that were not tested in a previous iteration of the MCTS algorithm and for which there is a score estimate associated with a simulated outcome.

Continuing with step S405, examples of a data action may include, but are not limited to: selecting action, deriving action, grouping action, etc. Examples of a deriving action can include, but is not limited to: discretization (e.g., binning, quantiles, timeframe such as year and date, etc.), binary operation logic (e.g., equal to, not equal to, less than, greater than, etc.), binary operation arithmetic (e.g., addition, subtraction, multiplication, division, etc.), where operation (which is a conjunction operation involving binary operations), etc.

Continuing with step S405, examples of the pattern action may include, but are not limited to: univariate statistics, bivariate statistics, virtual search tree, association rule, time series, clustering, statistical outliers, etc.

At step S406 of the flowchart process 400, the computing apparatus 202 may simulate an outcome based on the performed action.

At step S407 of the flowchart process 400, the computing apparatus 202 may update the MCTS algorithm by backpropagating a path score associated with the first branch based on the simulated outcome.

FIG. 5 illustrates an example overview framework process 500 (or process 500 for short) for generating the MCTS algorithm that detects data patterns according to an embodiment as described in FIG. 4 at steps S401-S407.

The process 500 may include an input with a dataset, such as a digital dataset, and domain knowledge. The digital dataset may be in a tabular form. The MCTS algorithm may be utilized to analyze the input by performing a search to determine interesting patterns in an unsupervised and/or semi-supervised setting. The space may involve potentially infinite possible data transformations and patterns that can be generated from the input. Thus, the MCTS algorithm may be utilized to perform a knowledge discovery of the input to extract non-trivial information from the input, such non-trivial information being previously unknown and potentially useful in describing a pattern within the input that is of interest to a user. The pattern becomes knowledge (hence knowledge discovery) when it meets the user's criteria of a predetermined interestingness metric (e.g., non-trivial, novel, useful, etc.) and certainty (i.e., the pattern is valid with a degree of confidence). The degree of confidence can be set by the user.

The process 500 may also include feature generation that may be performed on the digital dataset in conjunction with domain knowledge. Feature generation is a process of identifying and creating relevant features from raw data (e.g., the digital dataset), which is critical for effective data exploration. As such feature generation involves selecting the right variables that capture the underlying patterns and relationships within the data. Thus, feature generation can be a complex process that requires domain expertise and a deep understanding of the data. The MCTS algorithm may perform a feature generation process that includes combining primitive data types obtained from the digital data set, and constructing tabular data from a raw data obtained from the digital data set. That is, data transformation of a digital data set may include creating at least one subset of the digital data set and deriving data features from the digital data set.

The process 500 may also include pattern detection. The MCTS algorithm may perform a pattern detection that can detect various patterns such as clusters, trends, statistics, etc. The process 500 may also include pattern evaluation based on the detected pattern, wherein the MCTS algorithm may perform a pattern evaluation to measure a predetermined interestingness metric. The predetermined interestingness metric was previously described above. The process 500 may also include generating an output based on the evaluated pattern. The output may include interesting insights that was derived from the pattern evaluation. The output may be utilized by the MCTS algorithm for feedback/learning so that the MCTS algorithm can be updated accordingly. In an example, the output may include a simulated outcome and also include a path score regarding the path through a particular branch of the virtual search tree. This output with the path score may be used to update the MCTS algorithm by backpropagating the path score associated with the particular branch based on the simulated outcome. The particular branch may be a first branch, a second branch, etc. depending on which branch is currently being traversed and analyzed.

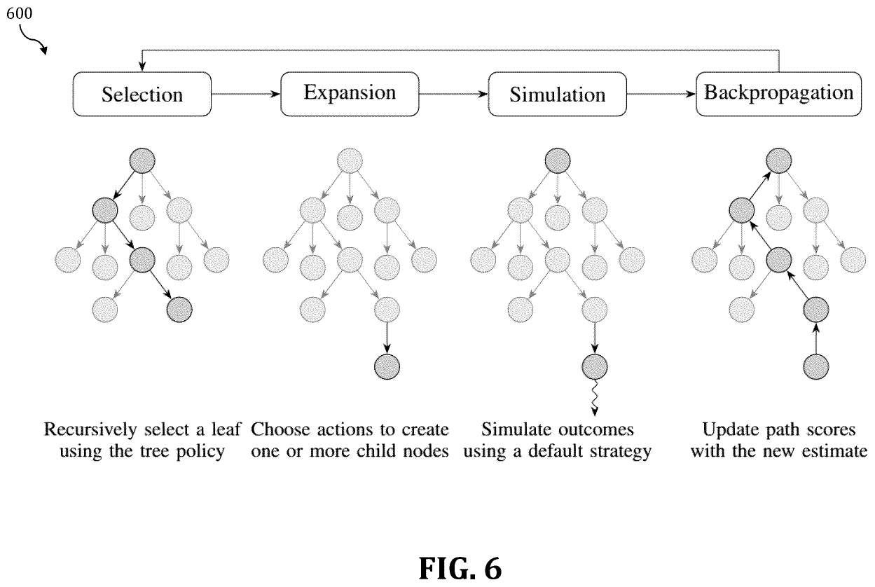

FIG. 6 illustrates an example of the MCTS algorithm search algorithm process as it traverses through a virtual search tree based on the generating a Monte Carlo tree search algorithm that detects data patterns 600 (or example 600 for short) according to an embodiment as described in FIG. 4 at steps S401-S407. In example 600, a selection process may be performed by recursively selecting a node based on the tree policy (i.e., MCTS algorithm). That is, the MCTS algorithm may perform the selection process by traversing a branch of the virtual search tree by the MCTS algorithm during an exploitation phase of the MCTS algorithm that recursively searches each node of the first branch to detect a predetermined data pattern. The MCTS algorithm may traverse the entirety of the branch until it reaches a terminal node or the MCTS algorithm may traverse the nodes of the branch until a stopping condition is triggered. For instance, the user can define a stopping condition for when the traversal should cease, e.g., after traversing a predetermined number of nodes for a predetermined amount of time or iterations and not finding an interesting feature, then stop traversing the current branch and jumping to a new branch. When jumping to a new branch, the MCTS algorithm may initially start again at a parent node or root node and then traverse the new branch until reaches a terminal node on the new branch or until the stopping condition is triggered.

Each node may correspond to a subset of data (e.g., digital data). A node may be a parent node or a child node. In example 600, the first node at the top may represent a parent node, whereas the nodes that subsequently depend from it may represent a child node. A node may also be called a leaf node since it may represent a leaf on the virtual search tree.

Example 600 may also include an expansion process wherein actions may be chosen by the MCTS algorithm to construct one or more child leaf nodes. The edges in the virtual search tree may denote actions, wherein actions may include both data actions and pattern actions. Examples of data actions may include, but are not limited to: add/derive features, grouping by, filtering, clustering, etc. Examples of pattern actions may include, but are not limited to: statistics, fitting of the virtual search tree, association rules, etc.

Example 600 may also include a simulation process, wherein the MCTS algorithm may simulate outcomes based on a default strategy. The default strategy may relate to pattern detection and pattern evaluation, i.e., a predetermined data pattern that may be based on a predetermined interestingness metric. That is, the MCTS algorithm may perform an action during an exploration phase upon the detection of the predetermined data pattern, and then simulate an outcome based on the performed action.

Example 600 may also include a backpropagation process to update the MCTS algorithm. The MCTS algorithm may be updated by backpropagating a path score associated with the branch being traversed based on the simulated outcome.

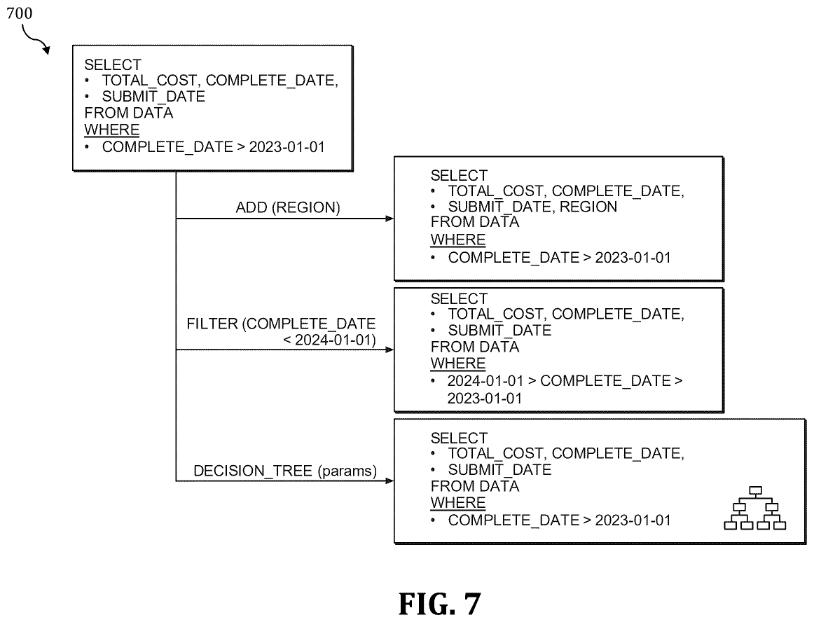

FIG. 7 illustrates an example pseudocode 700 based on the generating the MCTS algorithm that detects data patterns according to an embodiment as described in FIG. 4 at steps S401-S407. The example pseudocode 700 may show the selection process with data location (From Data), and a where operation. The pseudocode 700 may also show that different regions can also be added for analysis by the MCTS algorithm. Additionally, the example pseudocode 700 may also show a filtering process, wherein the filtering may be based on a timeframe. The example pseudocode 700 may also show parameters associated with the virtual decision to generate the virtual search tree. It is noted that the pseudocode is merely an example and the present application is not limited to this pseudocode. The present application can utilize any other pseudocode as applicable or desired.

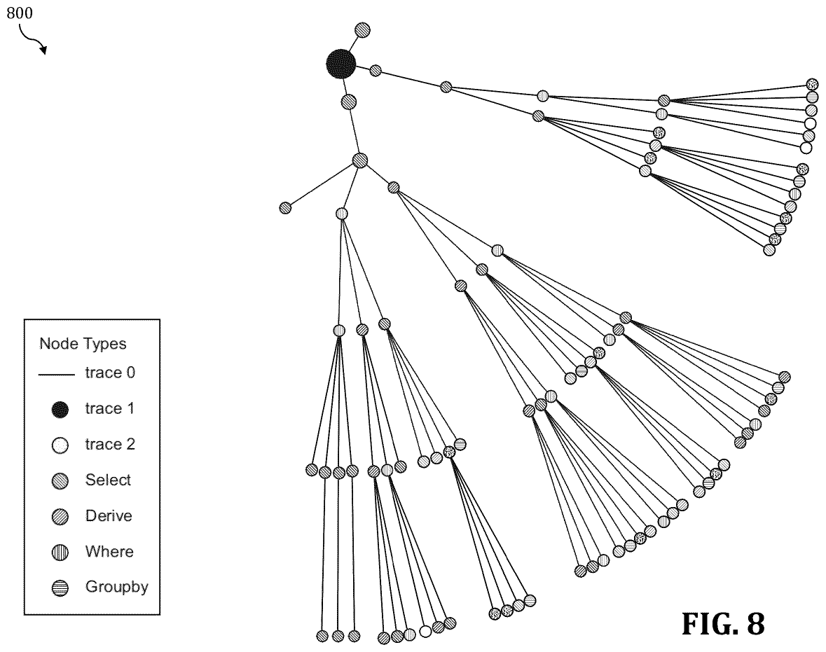

FIG. 8 illustrates an example of various nodes of a virtual search tree and traversing through the various nodes 800 (or example 800 for short) based on the generating the MCTS algorithm that detects data patterns according to an embodiment as described in FIG. 4 at steps S402 and S404. The example 800 may show a virtual search tree and the nodes associated with the virtual search tree. The center node is the parent node or root node. It may be seen in the example 800 that each branch has varying lengths due to the varying number of child nodes present on that particular branch.

The MCTS algorithm may begin the traversal of the virtual decision at the parent node or root node and traverse a branch of the virtual search tree until a terminal node (i.e., terminal child node) is reached or until a stopping condition is triggered. When jumping to a new branch, the MCTS algorithm would again begin at the parent node or root node and traverse down the new branch. The traversal may be denoted as a trace as shown in the example 800.

The example 800 may also show a categorization of the nodes based on a select process, a derivation process, a where operation, and a group by process.

Although the invention has been described with reference to several embodiments, it is understood that the words that have been used are words of description and illustration, rather than words of limitation. Changes may be made within the purview of the attached claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the attached claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the attached claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method of generating a Monte Carlo tree search algorithm that detects data patterns, the method being implemented by at least one processor, the method comprising:
performing a data transformation of a digital data set, wherein the data transformation comprises a creation of at least one subset of the digital data set and a derivation of data features from the digital data set;
constructing a virtual search tree with each node of the virtual search tree corresponding to the at least one subset of the digital data set with the derived data features;
generating a Monte Carlo tree search (MCTS) algorithm;
traversing a first branch of the virtual search tree by the MCTS algorithm during an exploitation phase of the MCTS algorithm that recursively searches each node of the first branch and detecting a predetermined data pattern indicating a trend formed by a specific sequence of nodes within the first branch of the virtual search tree;
performing an action during an exploration phase of the MCTS algorithm upon the detection of the predetermined data pattern, wherein the action has at least one pre-condition and at least one constraint that changes dynamically with each of the at least one subset of the digital data set, and wherein the action includes at least a data action and a pattern action;
simulating an outcome based on the performed action; and
updating the MCTS algorithm by backpropagating a path score associated with the first branch based on the simulated outcome.

2. The method of claim 1, wherein the predetermined data pattern comprises a predetermined interestingness metric; and
wherein the predetermined interestingness metric comprises a relevance dimension, a surprise dimension, a novelty dimension, and a peculiarity dimension.

3. The method of claim 1, wherein the performing the data transformation further comprises:
combining primitive data types obtained from the digital data set; and
constructing tabular data from a raw data obtained from the digital data set.

4. The method of claim 1, further comprising:
upon not reaching a predetermined number of iterations of the MCTS algorithm, traversing a second branch of the virtual search tree by the MCTS algorithm during the exploitation phase of the MCTS algorithm that recursively searches each node of the second branch to detect the predetermined data pattern.

5. The method of claim 1, further comprising:
performing an expansion by choosing the action that constructs additional nodes in the virtual search tree.

6. The method of claim 1, wherein the generating the MCTS algorithm comprises a computation of an upper confidence bound associated with the virtual search tree that comprises an average reward metric at the node, a number of visits at a parent node, a number of visits at the node, and a hyperparameter associated with the MCTS algorithm.

7. The method of claim 1, wherein the traversing of the first branch by the MCTS algorithm begins at a parent node and continues to a leaf node in the virtual search tree.

8. A computing apparatus for generating a Monte Carlo tree search algorithm that detects data patterns, comprising:
a processor;
a memory;
a display; and
a communication interface coupled to each of the processor, the memory, and the display, wherein the processor is configured to:
perform a data transformation of a digital data set wherein the data transformation comprises a creation of at least one subset of the digital data set and a derivation of data features from the digital data set;
construct a virtual search tree with each node of the virtual search tree corresponding to the at least one subset of the digital data set with the derived data features;
generate a Monte Carlo tree search (MCTS) algorithm;
traverse a first branch of the virtual search tree by the MCTS algorithm during an exploitation phase of the MCTS algorithm that recursively searches each node of the first branch and detect a predetermined data pattern indicating a trend formed by a specific sequence of nodes within the first branch of the virtual search tree;
perform an action during an exploration phase of the MCTS algorithm upon the detection of the predetermined data pattern, wherein the action has at least one pre-condition and at least one constraint that changes dynamically with each of the at least one subset of the digital data set, and wherein the action includes at least a data action and a pattern action;
simulate an outcome based on the performed action; and
update the MCTS algorithm by backpropagating a path score associated with the first branch based on the simulated outcome.

9. The computing apparatus of claim 8, wherein the predetermined data pattern comprises a predetermined interestingness metric; and
wherein the predetermined interestingness metric comprises a relevance dimension, a surprise dimension, a novelty dimension, and a peculiarity dimension.

10. The computing apparatus of claim 8, wherein the processor is configured to perform the data transformation by:
combining primitive data types obtained from the digital data set; and
constructing tabular data from a raw data obtained from the digital data set.

11. The computing apparatus of claim 8, wherein the processor is further configured to:
upon not reaching a predetermined number of iterations of the MCTS algorithm, traverse a second branch of the virtual search tree by the MCTS algorithm during the exploitation phase of the MCTS algorithm that recursively searches each node of the second branch to detect the predetermined data pattern.

12. The computing apparatus of claim 8, wherein the processor is further configured to perform an expansion by choosing the action that constructs additional nodes in the virtual search tree.

13. The computing apparatus of claim 8, wherein the processor is further configured to generate the MCTS algorithm by computing an upper confidence bound associated with the virtual search tree that comprises an average reward metric at the node, a number of visits at a parent node, a number of visits at the node, and a hyperparameter associated with the MCTS algorithm.

14. The computing apparatus of claim 8, wherein the processor is further configured to traverse the first branch by the MCTS algorithm by beginning at a parent node and continuing to a leaf node in the virtual search tree.

15. A non-transitory computer readable storage medium storing instructions for generating a Monte Carlo tree search algorithm that detects data patterns, the non-transitory computer readable storage medium comprising executable code which, when executed by a processor, causes the processor to:
perform a data transformation of a digital data set, wherein the data transformation comprises a creation of at least one subset of the digital data set and a derivation of data features from the digital data set;
construct a virtual search tree with each node of the virtual search tree corresponding to the at least one subset of the digital data set with the derived data features;
generate a Monte Carlo tree search (MCTS) algorithm;
traverse a first branch of the virtual search tree by the MCTS algorithm during an exploitation phase of the MCTS algorithm that recursively searches each node of the first branch and detect a predetermined data pattern indicating a trend formed by a specific sequence of nodes within the first branch of the virtual search tree;
perform an action during an exploration phase of the MCTS algorithm upon the detection of the predetermined data pattern, wherein the action has at least one pre-condition and at least one constraint that changes dynamically with each of the at least one subset of the digital data set, and wherein the action includes at least a data action and a pattern action;
simulate an outcome based on the performed action; and
update the MCTS algorithm by backpropagating a path score associated with the first branch based on the simulated outcome.

16. The non-transitory computer readable storage medium of claim 15, wherein the predetermined data pattern comprises a predetermined interestingness metric; and
wherein the predetermined interestingness metric comprises a relevance dimension, a surprise dimension, a novelty dimension, and a peculiarity dimension.

17. The non-transitory computer readable storage medium of claim 15, wherein the executable code further causes the processor to perform the data transformation by:
combining primitive data types obtained from the digital data set; and
constructing tabular data from a raw data obtained from the digital data set.

18. The non-transitory computer readable storage medium of claim 15, wherein the executable code further causes the processor to:
upon not reaching a predetermined number of iterations of the MCTS algorithm, traverse a second branch of the virtual search tree by the MCTS algorithm during the exploitation phase of the MCTS algorithm that recursively searches each node of the second branch to detect the predetermined data pattern.

19. The non-transitory computer readable storage medium of claim 15, wherein the executable code further causes the processor to perform an expansion by choosing the action that constructs additional nodes in the virtual search tree.

20. The non-transitory computer readable storage medium of claim 15, wherein the executable code further causes the processor to:
generate the MCTS algorithm by computing an upper confidence bound associated with the virtual search tree that comprises an average reward metric at the node, a number of visits at a parent node, a number of visits at the node, and a hyperparameter associated with the MCTS algorithm; and
traverse the first branch by the MCTS algorithm by beginning at the parent node and continuing to a terminal leaf node in the virtual search tree.
